(19) United States
(12) Patent Application Publication
(10) Pub. No.: US 2021/0365301 A1
(43) Pub. Date: Nov. 25, 2021

(54) SYSTEM AND METHOD FOR POWER AND THERMAL MANAGEMENT OF DISAGGREGATED SERVER SUBSYSTEMS

(71) Applicant: DELL PRODUCTS, LP, Round Rock, TX (US)

(72) Inventors: Balaji Bapu Gururaja Rao, Austin, TX (US); John Erven Jenne, Austin, TX (US); Elie Antoun Jreij, Pflugerville, TX (US); Shekar Babu Suryanarayana, Bangalore (IN)

(21) Appl. No.: 16/880,204

(22) Filed: May 21, 2020

(51) Int. Cl. G06F 9/50; G06F 3/06

(52) U.S. Cl. CPC G06F 9/5077; G06F 3/067; G06F 3/0605; G06F 3/0631

(57) ABSTRACT

A disaggregated information handling system includes processing sleds and an abstraction layer module. Each processing sled includes disaggregated processing elements. The abstraction layer module may discover the processing elements, determine an availability score for each of the processing elements, receive an allocation request for an allocation of at least one of the processing elements, and allocate a first one of the processing elements based upon the first processing element having a highest availability score.

### FIELD OF THE DISCLOSURE

This disclosure generally relates to information handling systems, and more particularly relates to power and thermal management of disaggregated server subsystems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A disaggregated information handling system may include a processing sleds and an abstraction layer module. The abstraction layer module may discover the processing elements, determine an availability score to each of the processing elements, receive an allocation request for an allocation of at least one of the processing elements, and allocate a first one of the processing elements based upon the first processing element having a highest availability score

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a disaggregated information handling system according to the prior art;

FIG. 2 is a block diagram illustrating a disaggregated information handling system according to an embodiment of the present disclosure;

FIG. 3 is a block diagram of a device specific server abstraction layer of the disaggregated information handling system of FIG. 2;

FIG. 4 is a flowchart illustrating a method for power and thermal management of disaggregated server subsystems according to an embodiment of the present disclosure: and

FIG. 5 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

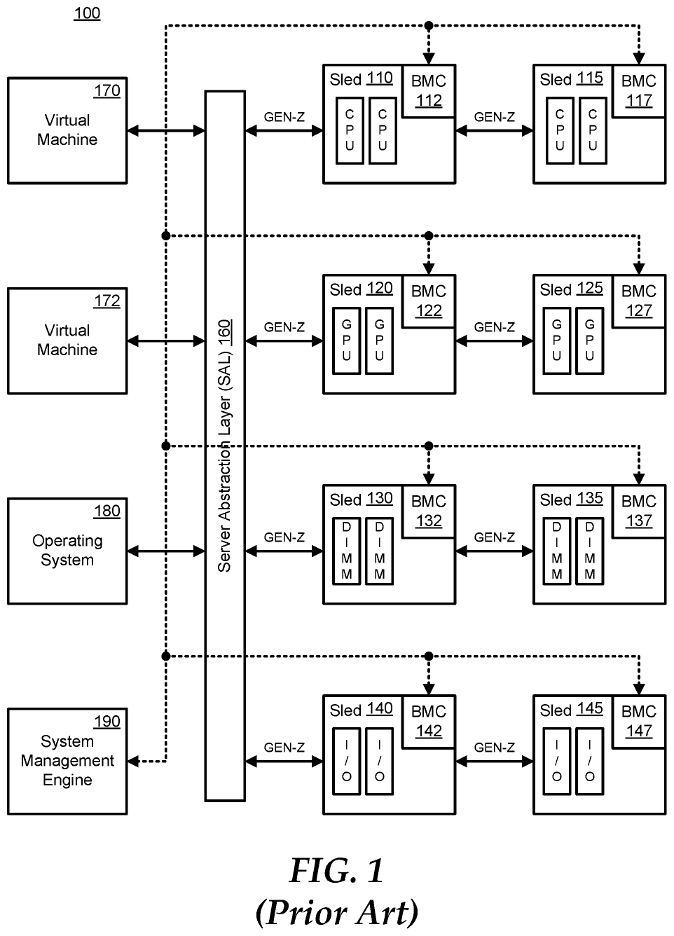

FIG. 1 illustrates a disaggregated information handling system 100 of the prior art. Disaggregated information handing system 100 includes central processing unit (CPU) sleds 110 and 115, graphic processing unit (GPU) sleds 120 and 125, memory sleds 130 and 135, input/output (I/O) sleds 140 and 145, a server abstraction layer (SAL) 160, virtual machines 170 and 172, an operating system 180, and a system management engine 190. Disaggregated information handling system 100 represents a datacenter architecture that breaks up the components of the traditional server or blade into self-contained component parts. Here, for example, a “sled” represents a chassis mounted processing node that provides a particular computing capability, such as general purpose processing (CPU sleds 110 and 115), directed processing (GPU sleds 120 and 125), memory capacity (memory sleds 130 and 135), and I/O and storage capacity (I/O sleds 140 and 145). Here, operating system 180 represents a virtualizing operating system akin to a hypervisor or virtual machine manager (VMM), with the difference that, instead of allocating resources of an integrated server system to the instantiated virtual machines, the operating system allocates the resources of sleds 110, 115, 120, 125, 130, 135, 140, and 145, to virtual machines 170 and 172.

In a particular case, sleds 110, 115, 120, 125, 130, 135, 140, and 145 each represent a removable chassis-mounted device. Here, a common chassis can be rack mountable in a standard 19-inch rack, and can provide common functionality for the installed sleds, such as power supplies, cooling fans, management, I/O, storage, and the like. Here further, each installed sled can represent a dedicated computing capability. For example, CPU sleds 110 and 115 can include a large number of processors, with enough associated memory, storage, and I/O to support the processors, but with not so much memory, storage, and I/O as would be normally associated with processors in a server system. Likewise, GPU sleds 120 and 125 may include a large number of GPUs and a modest general-purpose CPU sufficient to manage the GPUs, and with sufficient I/O capacity to handle the I/O needs of the GPUs. Further, memory sleds 130 and 135 may include large arrays of memory devices, such as Dual In-Line Memory Modules (DIMMs), again with sufficient processing and I/O to manage the memory devices. Finally, I/O sleds 140 and 145 may include large I/O capacity for storage arrays and network interfaces. Other types of sleds, such as dedicated storage sleds, network interface sleds, Field Programmable Gate Array (FPGA) sleds, Digital Signal Processing (DSP) sleds, and the like, may be included in disaggregated information handling system 100, as needed or desired. In another case, one or more installed sled can represent a general-purpose blade server with a more balanced mix of CPUs, co-processors such as GPUs, FPGAs, or DSPs, memory devices, and I/O capacity. Here, the various types of processing elements of a sled, while resident on a common removable chassis-mounted device, may be logically separated into the distinct processing modules based upon the type of processing elements included thereon: CPUs, co-processors, memory devices, and I/O devices, as needed or desired.

It may be understood that one or more of sleds 110, 115, 120, 125, 130, 135, 140, and 145 may represent an information handling system on its own, except that the information handling system in this case is provided to facilitate the use of each sled as a particular processing capacity. For example, GPU sleds 120 and 125 may include one or more general purpose processor or CPU, memory devices, storage devices, I/O devices, and the like. However, the use of such additional processing elements are provided to facilitate the function of the GPU sleds to provide GPU co-processing capabilities. For example, a CPU, memory, storage, and I/O may be provided to facilitate the receipt of processing task and the communication of the finished result of the processing tasks to aggregated information handling system 100.

SAL 160 represents a system orchestrator that presents the processing elements of sleds 110, 115, 120, 125, 130, 135, 140, and 145 as separate but virtualizable mix-and-match capabilities, and that allocates the processing elements as needed to virtual machines 170 and 172. For example, a particular virtual machine may be instantiated to provide a host for a workflow that has a fairly steady processing demand in terms of processing threads needed (CPU sleds 110 and 115), memory capacity (memory sleds 130 and 135), and storage and I/O capacity (I/O sleds 140 and 145). Another virtual machine may be instantiated to provide a host for a workflow that has a heavy demand for GPU processing (GPU sleds 120 and 125). A third virtual machine may be instantiated to provide a host for a workflow that has varying demands for processing power, GPU processing, memory, and I/O. Here, SAL 160 can operate to allocate the processing elements of sleds 110, 115, 120, 125, 130, 135, 140, and 145 to meet the needs of the virtual machines as the virtual machines are instantiated. As such, SAL 160 operates to dispatch and monitor workloads to the remote resources of sleds 110, 115, 120, 125, 130, 135, 140, and 145 as needed or desired. The details of allocating resources and dispatching and monitoring workloads in a disaggregated information handling system by a Server Abstraction Layer are known in the art and will not be further described herein except as needed to illustrate the present embodiments. SAL 160 may be implemented as hardware, software, firmware, or the like, as needed or desired. In particular, SAL 160 may represent a particular information handling system instantiated within disaggregated information handling system 100, or may be implemented utilizing a set of the processing elements of the disaggregated information handling system. In another case, SAL 160 may represent a module for managing disaggregated information handling system 100 that is included in operating system 180, or within a system Basic Input/Output System or Universal Extensible Firmware Interface (BIOS/UEFI) of the disaggregated information handling system.

Broadly, the disaggregation of processing elements as described herein is referred to under the moniker of “XaaS:” CPU-as-a-Service (CPUaaS), GPU-as-a-Service (CPUaaS), Memory-as-a-Service, I/O-as-a-Service, and the like. The ability to effectively disaggregate the processing elements of disaggregated information handling system 100, and to provide XaaS functionality, is facilitated by the emergence of various high-speed open-standard data communication standards for communications between processor/compute nodes, co-processor nodes, memory arrays, storage arrays, network interfaces, and the like. Examples of such communication standards include the Gen-Z Consortium standard, the Open Coherent Accelerator Processor Interface (OpenCAPI) standard, the Open Memory Interface (OMI) standard, the Compute Express Link (CXL) standard, or the like. As illustrated herein, the disaggregated information handling systems of the present embodiments are shown as linking the various sleds via Gen-Z links, but this is not necessarily so, and other high-speed communication links may be utilized in connection with the present embodiments, as needed or desired. It will be further understood that the division of processing capacities as shown and described herein are for illustrative purposes, and are not meant to limit the scope of the teachings herein. For example, other divisions may be contemplated as needed or desired, such as where various sleds may incorporate CPU and memory capacities, or where other types of co-processors, such as FPGAs or DSPs, or other co-processors are utilized in place of, or in addition to the illustrated GPU sleds.

In a particular embodiment, one or more of sleds 210, 215, 220, 225, 230, 235, 240, and 245 represent an information handling system on its own, except that the information handling system in this case is provided to facilitate the use of each sled as a particular processing capacity. For example, GPU sleds 220 and 225 may include one or more general purpose processor or CPU, memory devices, storage devices, I/O devices, and the like. However, the use of such additional processing elements are provided to facilitate the function of the GPU sleds to provide GPU co-processing elements. For example, a CPU, memory, storage, and I/O may be provided to facilitate the receipt of processing task and the communication of the finished result of the processing tasks to aggregated information handling system 2d00.

Sleds 110, 115, 120, 125, 130, 135, 140, and 145 each include an associated baseboard management controller (BMC) 112, 117, 122, 127, 132, 137, 142, and 147, respectively. BMCs 112, 117, 122, 127, 132, 137, 142, and 147 are connected to system management engine 190 by a management network. BMCs 112, 117, 122, 127, 132, 137, 142, and 147 each represent one or more processing devices, such as a dedicated BMC System-on-a-Chip (SoC) device, one or more associated memory devices, one or more network interface devices, a complex programmable logic device (CPLD), and the like, that operate together to provide a management environment for disaggregated information handling system 100. In particular, each BMC 112, 117, 122, 127, 132, 137, 142, and 147 is connected to various components of the associated sled 110, 115, 120, 125, 130, 135, 140, and 145 via various internal communication interfaces, such as a Low Pin Count (LPC) interface, an Inter-Integrated-Circuit (I2C) interface, a Peripheral Component Interconnect-Express (PCIe) interface, or the like, to provide an out-of-band (OOB) mechanism to retrieve information related to the operation of the associated sled, to provide BIOS/UEFI or system firmware updates, to manage non-processing components of the sleds, such as system cooling fans and power supplies. An example of BMCs 112, 117, 122, 127, 132, 137, 142, and 147 may include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. In a particular case where sleds 110, 115, 120, 125, 130, 135, 140, and 145 each represent a removable chassis-mounted device, BMCs 112, 117, 122, 127, 132, 137, 142, and 147 may represent dedicated BMCs, one for each sled. Here, the common chassis may include a Chassis Management Controller (CMC) that is connected to the BMC of each sled in the chassis, and that provides a central point of communication for managing the functions of the chassis and of the sleds within the chassis.

In the prior art solutions for providing XaaS, such as in disaggregated information handling system 100, the management, monitoring, and maintenance of power, thermal, and acoustic properties of sleds 110, 115, 120, 125, 130, 135, 140, and 145 is typically done on a per-sled basis. Here, for example, system management engine 100 operates to aggregate thermal information for sleds 110, 115, 120, 125, 130, 135, 140, and 145 individually, or, at most, upon a per-chassis basis. Moreover, in large datacenters that may provide XaaS capabilities, various sleds may be employed by different manufacturers that each provide different tools, techniques, and algorithms for the management of their respective power, thermal, and acoustic functions. However, because management of sleds 110, 115, 120, 125, 130, 135, 140, and 145 by system management engine 190 is on a per-sled or per-chassis basis, power or thermal issues on a particular sled may necessitate degrading the performance of all workloads operating on that particular sled, or, in a worst case, may necessitate the complete shut down of the processing elements of the particular sled. In such extreme cases, the shutting down of a particular sled may necessitate the un-mapping and remapping of the computing resources for each particular workload, and the associated migration and re-instantiation of the associated virtual machines. Such migration and re-instantiation of virtual machines typically result in unacceptable performance degradation within the datacenter. Issues that may result in degraded performance may include: power efficiency degradations resulting from increased fan power consumption, the operating of power supply units (PSUs) on less efficient points on the associated PSU efficiency curve, or the like; power delivery related performance degradation resulting from PSU, power grid faults due to over-subscribed configuration, or the like; thermal related performance degradation resulting from operations at higher than supported ambient temperatures, fan faults, configurations that exceed fan-only thermal management parameters, exhaust temperature limitations, or the like; and datacenter related performance degradation due to user-defined power caps assigned to the sleds or chassis or the like.

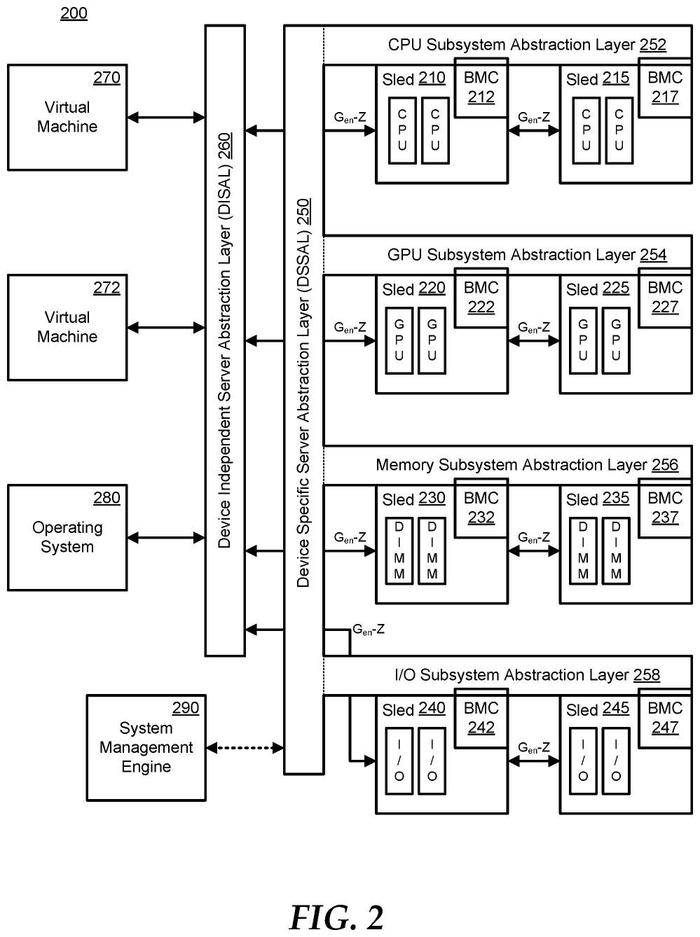

FIG. 2 illustrates a disaggregated information handling system 200 according to an embodiment of the present disclosure. Disaggregated information handing system 200 includes central processing unit (CPU) sleds 210 and 215, graphic processing unit (GPU) sleds 220 and 225, memory sleds 230 and 235, input/output (I/O) sleds 240 and 245, a device specific server abstraction layer (DSSAL) 250, a device independent server abstraction layer (DISAL) 260, virtual machines 270 and 272, an operating system 280, and a system management engine 290. Disaggregated information handling system 200 is similar to disaggregated information handling system 100, representing a datacenter architecture that breaks up the components of the traditional server or blade into self-contained component parts. Sleds 210, 215, 220, 225, 230, 225, 240, and 245 are similar to sleds 110, 115, 120, 125, 130, 135, 140, and 145, representing chassis mounted processing nodes that each provide particular processing elements, such as general purpose processing (CPU sleds 210 and 215), directed processing (GPU sleds 220 and 225), memory capacity (memory sleds 230 and 235), and I/O and storage capacity (I/O sleds 240 and 245). Here, operating system 280 is similar to operating system 180, representing a virtualizing operating system that allocates the resources of sleds 210, 215, 220, 225, 230, 235, 240, and 245, to virtual machines 270 and 272.

DISAL 260 represents the processing elements of sleds 210, 215, 220, 225, 230, 235, 240, and 245 as separate but virtualizable mix-and-match processing elements that can be allocated as needed to virtual machines 270 and 272. For example, a particular virtual machine may be instantiated to provide a host for a workflow that has a fairly steady processing demand in terms of processing threads needed (CPU sleds 210 and 215), memory capacity (memory sleds 230 and 235), and storage and I/O capacity (I/O sleds 240 and 245). Another virtual machine may be instantiated to provide a host for a workflow that has a heavy demand for GPU processing (GPU sleds 220 and 225). A third virtual machine may be instantiated to provide a host for a workflow that has varying demands for processing power, GPU processing, memory, and I/O. Here, DISAL 260 can operate to allocate the processing elements of sleds 210, 215, 220, 225, 230, 235, 240, and 245 to meet the needs of the virtual machines as the virtual machines are instantiated. As such, DISAL 260 operates to dispatch and monitor workloads to the remote resources of sleds 210, 215, 220, 225, 230, 235, 240, and 245 as needed or desired. In a particular embodiment, DSSAL 250 and DISAL 260 are implemented as hardware, software, firmware, or the like, as needed or desired. In particular, DSSAL 250 and DISAL 260 may represent a particular information handling system instantiated within disaggregated information handling system 200, or may be implemented utilizing a set of the processing elements of the disaggregated information handling system. In another embodiment, DSSAL 250 and DISAL 260 each represent a module for managing disaggregated information handling system 200 that is included in operating system 280, or within a system BIOS/UEFI of the disaggregated information handling system.

Sleds 210, 215, 220, 225, 230, 235, 240, and 245 each include an associated baseboard management controller (BMC) 212, 217, 222, 227, 232, 237, 242, and 247, respectively. BMCs 212, 217, 222, 227, 232, 237, 242, and 247 are similar to BMCs 112, 127, 122, 127, 132, 137, 142, and 147 in their operations with respect to their associated sleds 210, 215, 220, 225, 230, 235, 240, and 245. That is, in terms of a particular BMCs operability to monitor, manage, and maintain the associated sled, BMCs 212, 217, 222, 227, 232, 237, 242, and 247 operate similarly to BMCs 112, 127, 122, 127, 132, 137, 142, and 147, as described above. However, where BMCs 112, 127, 122, 127, 132, 137, 142, and 147 are each connected to system management engine 190 via a management network, BMCs 212, 217, 222, 227, 232, 237, 242, and 247 are each connected to system management engine 290 via DSSAL 250. In particular, DSSAL 250 includes a CPU subsystem abstraction layer 252 that is connected to BMCs 212 and 217, a GPU subsystem abstraction layer 254 that is connected to BMCs 222 and 227, a memory subsystem abstraction layer 256 that is connected to BMCs 232 and 237, and an I/O subsystem abstraction layer 258 that is connected to BMC 242, and 247. Here, the common chassis may include a CMC that is connected to the BMC of each sled in the chassis, and that provides a central point of communication for managing the functions of the chassis and of the sleds within the chassis. Here CPU subsystem abstraction layer 252, GPU subsystem abstraction layer 254, memory subsystem abstraction layer 256, and I/O subsystem abstraction layer 258 represent abstraction layers not necessarily for the allocation of the resources of sleds 210, 215, 220, 225, 230, 235, 240, and 245 to virtual machines 270 and 270, as provided by DISAL 260, but more particularly represent abstraction layers for the aggregate computing functions, and the maintenance, management, and monitoring of the resources of the sleds.

In particular, the management, monitoring, and maintenance of power, thermal, and acoustic properties of sleds 210, 215, 220, 225, 230, 235, 240, and 245 is done on an aggregate basis. For example, the CPUs included on CPU sleds 210 and 215 are presented by CPU subsystem abstraction layer 252 as an aggregate processing capacity, and can allocate and deallocated particular CPUs to the use of virtual machines 170 and 172 without having to halt or migrate the virtual machines when the allocations of CPUs changes. In particular, CPU subsystem abstraction layer maintains knowledge of the operating functions and features of CPU sleds 212 and 215, and so can store machine state for a particular CPU and capture instructions provided by a virtual machine, and so can halt the flow of instructions to a particular CPU, save the machine state for that CPU, initialize a different CPU on a different sled with the saved machine state, and provide the halted instruction flow to the new CPU, and this can be performed seamlessly, without interrupting the associated virtual machine, DISAL 260, or operating system 280. Similarly, GPU subsystem abstraction layer 254 presents the GPUs of GPU sleds 220 and 225 as an aggregated GPU capacity, and can allocate and deallocated particular GPUs to the use of virtual machines 170 and 172 without having to halt or migrate the virtual machines when the allocation of GPUs changes. Likewise memory subsystem abstraction layer 256 presents the memory devices of memory sleds 230 and 235 as aggregated memory capacity, and I/O subsystem abstraction layer 258 presents the I/O devices of I/O sleds 240 and 245 as aggregated I/O capacities. In this way, when DISAL 260, virtual machines 170 and 172, and operating system 280 determine that a resource is needed, DISAL provides an aggregated demand to DSSAL 150, and the DSSAL manages the allocation seamlessly, and without further management or instruction from the DISAL.

Here, where the various sleds employ different tools, techniques, and algorithms for the management of their respective power, thermal, and acoustic functions, the subsystem abstraction layers are provided with the specific knowledge of the functions, thereby freeing DISAL 260, and operating system 280 from having to maintain specific knowledge to manage the power, thermal, and acoustic functions of the sleds. As noted above, DSSAL 250 and subsystem abstraction layers 252, 254, 256, and 258 can operate at the behest of one or more of DISAL 260, virtual machines 170 and 172, and operating system 280, as needed to meet the processing demands of the instantiated virtual machines.

In addition, DSSAL 250 and subsystem abstraction layers 252, 254, 256, and 258 can operate at the behest of system management engine 290 to manage the power, thermal, and acoustic functions of sleds 210, 215, 220, 225, 230, 235, 240, and 245. In particular, system management engine 290 operates through DSSAL 250 and subsystem abstraction layers 252, 254, 256, and 258 to actively manage, maintain, and monitor the power, thermal, and acoustic properties of sleds 210, 215, 220, 225, 230, 235, 240, and 245. For example, system management engine 290 can determine from memory subsystem abstraction layer 256 that sled 230 is consuming excess power, is running too hot, is running too loud, is having other environmental or auxiliary problems, or the like, and the system management engine can direct the memory subsystem abstraction layer to reallocate memory from memory sled 230 to memory sled 235. Here, memory subsystem abstraction layer 256 operates to transfer the data stored on a memory device of sled 230 to a memory device of sled 235, and then to remap memory access requests from the initial memory device to the new memory device. Here, not only is the hosted environment, represented by DISAL 260, virtual machines 170 and 172, and operating system 180, unaware of any change in the configuration, but system management engine 290 gains the ability to manage the processing resources of disaggregated information handling system 200 in order to optimize the resource utilization, to manage power, thermal, acoustic, an other environmental or auxiliary characteristics of the information handling system as an integrated whole, as opposed to the case with disaggregated information handling system 100, where management is provided on a per-sled basis.

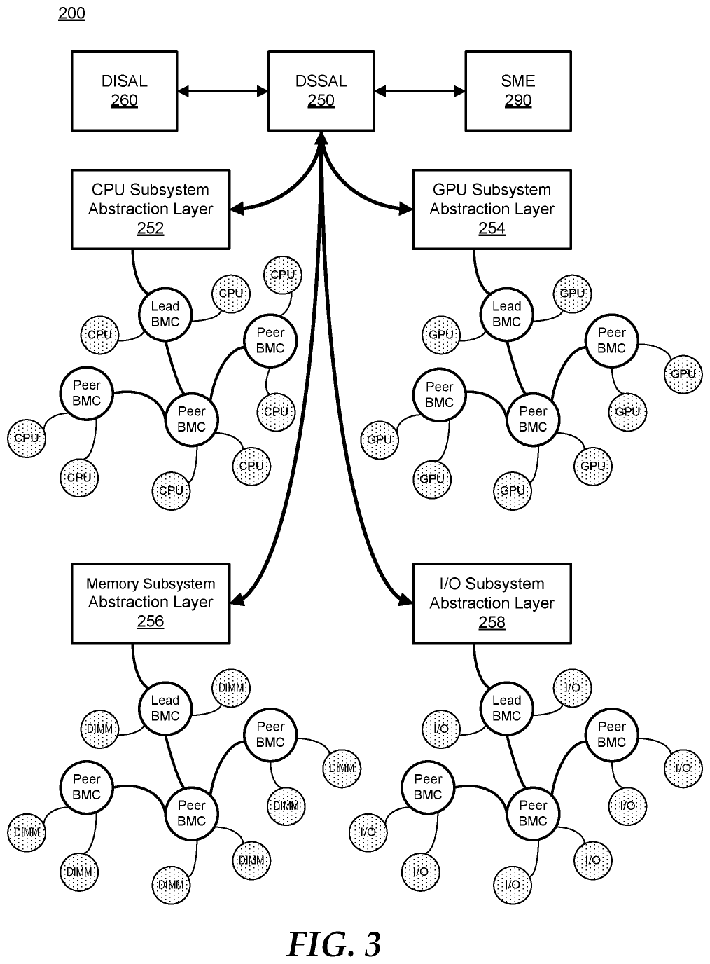

FIG. 3 illustrates disaggregated information handling system 200, and in particular, the management network implemented by DSSAL 250, CPU subsystem abstraction layer 252, GPU subsystem abstraction layer 254, memory subsystem abstraction layer 256, I/O subsystem abstraction layer 258, DISAL 260, and system management engine 290. Here, each subsystem abstraction layer 252, 254, 256, and 258 includes a lead BMC that is in communication with one or more peer BMC. The lead BMC may represent a particular BMC included within a sled, that manages, maintains, and monitors the particular sled, but also functions as a centralized BMC through which the associated system abstraction layer communicates to the peer BMCs. The lead BMC may also represent a CMC in a common chassis that is connected to the BMC of each sled in the chassis, and through which the associated system abstraction layer communicates to the peer BMCs of the sleds. Here, when a resource, such as a CPU, a GPU, a memory device, an I/O device, or the like, is requested by DISAL 260, the lead BMC communicates with the peer BMCs to identify the resource to be mapped to the DISAL. Here, DSSAL 250, each subsystem abstraction layer 252, 254, 256, and 258 operates to utilize a node allocation criterion in selecting the resources to be allocated to DISAL 260, as described below.

In a particular embodiment, DSSAL 250 operates to allocate the resources of disaggregated information handling system 200 on a per node basis, where each resource is treated as a particular type of processing node. Here, each node is given a score for a variety of parameters, including node power efficiency, node performance, and node availability. In a particular embodiment, each node is provided a score as provided in Equation 1:

A=xN_{PE}+yN_{PF}+zN_{A} Equation 1

where A is the availability score, N_{PE} is the node power efficiency, N_{PF} is the node performance level, N_{A} is the node availability, and x, y, and z are weighting factors. The node parameters N_{PE}, N_{PF}, and N_{A} are each ascribed a score, for example of 1-10, where “1” is a least optimal state for the node for the particular parameter, and “10” is a most optimal state for the node for the particular parameter. The weighting factors x, y, and z are set to equal “1,” indicating that each parameter is given an equal weight. When DISAL 260 requests a resources of a particular type, then DSSAL 250 selects the nodes of the particular type with the highest scores. In a particular embodiment, the weighting factors x, y, and z are configurable, such that a user of disaggregated information handling system 200 may set the weighting factors to be greater than or less than “1,” as needed or desired.

In a particular embodiment, the node power efficiency, N_{PE}, is measured as a Power Usage Effectiveness (PUE) for the sled that includes the particular node. That is, it may be difficult to determine a power efficiency on a per-node basis, but the PUE for each sled can be utilized as an assumed power efficiency for the nodes within each sled. Here, the PUE can be calculated as:

PUE=P_{S}/P_{C} Equation 2

where P_{S} is the total sled power level and P_{C} is the compute component power level. The total sled power level, P_{S}, includes fans, voltage regulators, power supply efficiency losses, board power distribution losses, and the like. The compute power level, P_{C}, includes processor power, memory power, I/O power, storage power, and the like. Here, a BMC in each sled operates to monitor the various power levels within the sled and to calculate the PUE for the sled in accordance with Equation 2. For example, a BMC may receive indications as to a PSU efficiency, such as by evaluating a PSU load percentage against a stored PSU efficiency curve, and may determine whether an increase in the load will result in the PSU operating less efficiently. The BMC may also receive indications as to fan power levels, such as a measured power, a Pulse-Width Modulation (PWM) level at which the fans are being operated, and the like.

The node performance level, N_{PF}, can be determined by the BMC within a particular sled based upon a the operating frequency for the various processing elements of the sled, such as CPUs, memory devices, I/O devices, and the like, based upon a determination that an increase in the load on the sled may result in the activation of various power and thermal control loops, waring or error status indications for power or thermal throttling, and the like. The node availability, N_{A}, may be determined based upon warning or error status indications that power, fan, memory, I/O, or other redundancy has been lost, indications that the source power for the sled or chassis is considered dirty, resulting in frequent drop-outs of the PSU, and the like.

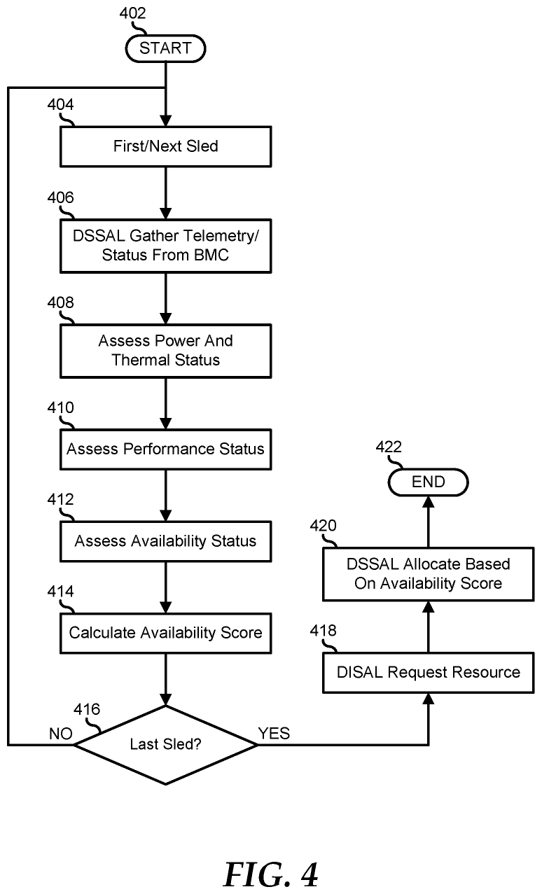

FIG. 4 illustrates a method for power and thermal management of disaggregated server subsystems starting at block 402. A first sled of the disaggregated information handling system is selected in block 404, and a DSSAL of the disaggregated information handling system gathers telemetry data and status information from the BMCs in the current sled in block 406. The DSSAL assess the power and thermal telemetry and status information from the BMCs, and assigns a power node efficiency level, N_{PF}, for the processing elements in the current sled in block 408. The DSSAL asses the performance telemetry and status information from the BMCs and assigns a node performance level, N_{PF}, for the processing elements in the current sled in block 410. The DSSAL asses the availability telemetry and status information from the BMCs and assigns a node availability, N_{A}, for the processing elements in the current sled in block 412. The DSSAL calculates an availability for each node in block 414. For example, the DSSAL can utilize Equation 1, above, to calculate the availability for each node.

A decision is made as to whether or not the selected sled is the last sled in the disaggregated information handling system in decision block 416. If not, the “NO” branch of decision block 406 is taken and the method returns to block 404 where a next sled of the disaggregated information handling system is selected. If the selected sled is the last sled in the disaggregated information handling system, the “YES” branch of decision block 406 is taken, and a DISAL of the disaggregated information handling system requests resources to ascribe to a virtual machine in block 418. The DSSAL allocates one or more node to satisfy the resource request based upon each node's availability score in block 420 and the method ends in block 422.

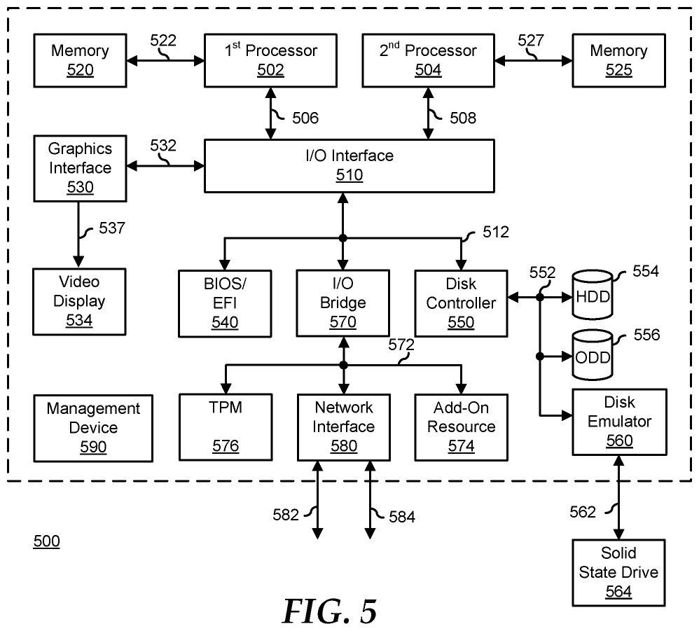

FIG. 5 illustrates a generalized embodiment of an information handling system 500 similar to information handling system 100. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below, and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532, and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 1394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512, or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500. Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A disaggregated information handling system, comprising:
a plurality of processing sleds, each sled including a plurality of disaggregated processing elements; and
a first abstraction layer module instantiated on the disaggregated information handling system, the first abstraction layer module configured to:
discover the processing elements;
determine an availability score for each of the processing elements;
receive an allocation request for an allocation of at least one of the processing elements; and
allocate a first one of the processing elements based upon the first processing element having a highest availability score.

2. The disaggregated information handling system of claim 1, further comprising:
a second abstraction layer module instantiated on the disaggregated information handling system, the second abstraction layer module configured to:
receive processing request from an operating system instantiated on the disaggregated information handling system; and
send the allocation request to the first abstraction layer module based upon the processing request.

3. The disaggregated information handling system of claim 2, wherein the first abstraction layer module is further configured to:
receive a deallocation request to deallocate the first processing element; and
deallocate the first processing element in response to the deallocation request.

4. The disaggregated information handling system of claim 3, wherein:
the processing request is from a virtual machine instantiated by the operating system; and
the second abstraction layer module is further configured to:
receive a request from the virtual machine to deallocate the first processing element; and
send the deallocation request to the first abstraction layer module.

5. The disaggregated information handling system of claim 1, wherein, for each processing element, the availability score is determined as:
A=xN_{PE}+yN_{PF}+zN_{A}
where A is the availability score, N_{PE} is power efficiency for the processing element, N_{PF} is the performance level for the processing element, N_{A} is the availability for the processing element, and x, y, and z are weighting factors.

6. The disaggregated information handling system of claim 5, wherein x, y, and z are equal to “1.”

7. The disaggregated information handling system of claim 5, wherein x, y, and z are user selectable.

8. The disaggregated information handling system of claim 5, wherein the power efficiency, N_{PE}, is based upon at least one of a processor power, a memory power, an I/O power, and a storage power.

9. The disaggregated information handling system of claim 5, wherein the performance level, N_{PF}, is based upon an operating frequency of the processing element.

10. The disaggregated information handling system of claim 5, wherein the availability, N_{A}, is based upon at least one of a fan warning, a memory warning, and an I/O warning.

11. A method for managing a disaggregated information handling system, the method comprising:
discovering, by a first abstraction layer module instantiated on the disaggregated information handling system, processing elements of the disaggregated information handling system, the processing elements being included in a plurality of processing sleds;
determining an availability score to each of the processing elements;
receiving an allocation request for an allocation of at least one of the processing elements; and
allocating a first one of the processing elements based upon the first processing element having a highest availability score.

12. The method of claim 11, further comprising:
receiving, by a second abstraction layer module instantiated on the disaggregated information handling system, a processing request from an operating system instantiated on the disaggregated information handling system; and
sending, by the second abstraction layer module, the allocation request to the first abstraction layer module based upon the processing request.

13. The method system of claim 12, further comprising:
receiving a deallocation request to deallocate the first processing element; and
deallocating the first processing element in response to the deallocation request.

14. The method of claim 13, wherein:
the element request is from a virtual machine instantiated by the operating system; and
the method further comprises:
receiving a request from the virtual machine to deallocate the first processing element; and
sending the deallocation request to the first abstraction layer module.

15. The method of claim 11, wherein, for each processing element, the availability score is determined as:
A=xN_{PE}+yN_{PF}+zN_{A}
where A is the availability score, N_{PE} is power efficiency for the processing element, N_{PF} is the performance level for the processing element, N_{A} is the availability for the processing element, and x, y, and z are weighting factors.

16. The method of claim 15, wherein x, y, and z are equal to “1.”

17. The method of claim 15, wherein x, y, and z are user selectable.

18. The method of claim 15, wherein:
the power efficiency, N_{PE}, is based upon at least one of a processor power, a memory power, an I/O power, and a storage power;
the performance level, N_{PF}, is based upon an operating frequency of the processing element; and
the availability, N_{A}, is based upon at least one of a fan warning, a memory warning, and an I/O warning.

19. A disaggregated information handling system, comprising:
a plurality of processing sleds each including a plurality of disaggregated processing elements;
a first abstraction layer module instantiated on the disaggregated information handling system, the first abstraction layer module configured to:
discover the processing elements;
determine an availability score for each of the processing elements wherein, for each processing element, the availability score is determined as:
A=xN_{PE}+yN_{PF}+zN_{A}
where A is the availability score, N_{PE} is power efficiency for the processing element, N_{PF} is the performance level for the processing element, N_{A} is the availability for the processing element, and x, y, and z are weighting factors;
receive an allocation request for an allocation of at least one of the processing elements; and
allocate a first one of the processing elements based upon the first processing element having a highest availability score; and
a second abstraction layer module instantiated on the disaggregated information handling system, the second abstraction layer module configured to:
receive a processing request from an operating system instantiated on the disaggregated information handling system; and
send the allocation request to the first abstraction layer module based upon the processing request.

20. The method of claim 19, wherein:
the power efficiency, N_{PE}, is based upon at least one of a processor power, a memory power, an I/O power, and a storage power;
the performance level, N_{PF}, is based upon an operating frequency of the processing element; and
the availability, N_{A}, is based upon at least one of a fan warning, a memory warning, and an I/O warning.
